(19) United States
(12) Patent Application Publication
(10) Pub. No.: US 2006/0164061 A1
(43) Pub. Date: Jul. 27, 2006

(54) Single wire interface providing analog and digital communication between an AC power adapter and an electronic device

(75) Inventors: Jose Antonio Vieira Formenti, Allen, TX (US); Garry Ross Elder, Spratton (GB)

Correspondence Address: TEXAS INSTRUMENTS INCORPORATED, P O BOX 655474, M/S 3999, DALLAS, TX, 75265, US

(73) Assignee: TEXAS INSTRUMENTS INCORPORATED

(21) Appl. No.: 11/044,797

(22) Filed: Jan. 27, 2005

(51) Int. Cl. F02P 3/02

(52) U.S. Cl. 323/371

(57) ABSTRACT

A single wire interface between an AC power adapter and end equipment, such as a notebook computer, conveys digital information from the adapter to the end equipment when the adapter is operative in a first operating mode and carries an analog signal employed in a closed loop to control the DC output voltage of the AC power adapter when the AC adapter is operative in a second operating mode. When the AC adapter is operative in the first operating mode, the AC adapter output voltage is clamped to a first predetermined voltage and when the AC adapter is operative in the second operating mode the output voltage is clamped to a second predetermined voltage, wherein the first predetermined voltage is less than the second predetermined voltage. Mechanisms for switching between the first and second operating modes are also provided.

### CROSS REFERENCE TO RELATED APPLICATIONS

Not Applicable

### STATEMENT REGARDING FEDERALLY SPONSORED RESEARCH OR DEVELOPMENT

Not Applicable

### BACKGROUND OF THE INVENTION

The present application relates to AC power adapters for powering electronic equipment such as notebook computers, and more specifically, to AC power adapters employed with battery powered electronic equipment such as notebook computers.

The use of AC power adapters to power portable electronic equipment is well known. AC power adapters are known that employ switching converters to produce a DC adapter output voltage. It is understood that when an AC adapter applies an output voltage to the powered electronic equipment in excess of an acceptable voltage limit, the circuitry in the electronic equipment may be damaged.

Typical AC adapters produce a fixed output voltage from AC power. The end equipment being powered commonly includes a linear stage or a switching mode DC to DC converter that is employed to implement battery charger functions in battery powered systems. Control loops that are used to assure that proper voltages are applied to recharge batteries and to power the end equipment are typically provided in the end equipment. The inclusion of such DC to DC converters and associated control loops in the end equipment has a number of disadvantages. The components associated with the DC to DC converters and/or the linear stage power components add undesirable heat and weight to the end equipment. This is particularly undesirable in notebook computers where there is an ever increasing desire to produce smaller and lighter products.

When powering and recharging batteries in end equipment via an AC adapter, the AC adapter usually has a module that contains the adapter circuitry. A power cord connects the module to AC line power and another interface cable connects the AC adapter to the end equipment. It is desirable for the interface cable to be flexible for ease of use and it is also desirable for the AC adapter to be of light weight since, as in the case of notebook computers, it is often transported with the equipment.

For these reasons, an improved system and method for interfacing an AC adapter to battery operated electronic equipment that avoids the above-identified disadvantages of known AC adapters-end equipment interfaces would be desirable.

### BRIEF SUMMARY OF THE INVENTION

In a system including an AC adapter and an electronic device which is optionally powered by a battery pack, such as a notebook computer, an improved system and method for controlling the output voltage of the AC adapter and for obtaining information from the AC adapter via a single wire interface is disclosed. More specifically, the AC adapter includes AC line powered primary side circuitry, such as a flyback converter, and secondary side circuitry that generates a DC output voltage. First and second control loops feed back an error signal through optical isolators to the primary side circuirty to control the AC adapter output voltage. The DC output voltage from the AC adapter is coupled to the end equipment, such as a notebook computer and serves to power the electronic device and to charge a battery pack that is electrically coupled to the electronic device.

The interface between the AC adapter and the end equipment includes two wires for coupling the positive and negative DC output voltages to the end equipment. In addition, the interface between the AC adapter and the end equipment includes a single wire that serves as a control and data link. The control and data link carries digital information when the AC adapter is in a first operating mode and carries analog information when the AC adapter is operating in a second operating mode.

In the first operating mode, a host within the end equipment retrieves digital information from the AC adapter to identify the AC adapter and/or an electrical characteristic pertaining to the AC adapter. In the first operating mode, the AC adapter outputs a DC voltage that is a percentage of the maximum DC output voltage of the adapter.

In the second operating mode the end equipment controls an analog error signal via the control and data link. The analog error signal is applied to the primary side of the AC adapter to adjust the primary side duty cycle of the input converter to control the AC adapter output voltage. More specifically, in one embodiment, the end equipment includes a current sink that sinks a current in a closed loop with the AC adapter to control the AC adapter output voltage. In the second operating mode, the AC adapter outputs the maximum DC output voltage.

Additionally, a protocol provides for the transition between the first and second operating modes to assure that the AC adapter does not apply an excessive output voltage to the electronic device which may cause damage to the circuitry within the battery-operated device during power up or during use.

Other features, aspects, and advantages of the above described system and method will be apparent to those of ordinary skill of the art from the detailed description of the invention that follows.

### BRIEF DESCRIPTION OF THE SEVERAL VIEWS OF THE DRAWINGS

The invention will be more fully understood by reference to the following detailed description of the invention in conjunction with the drawings of which:

FIG. 1 is a block diagram of a system, including an AC adapter operative in accordance with the present invention;

FIG. 2 is a block diagram depicting the adapter of FIG. 1 in greater detail;

FIG. 3 is a block diagram of end equipment cooperative with the AC adapter of FIG. 2; and

FIG. 4 is a flow chart depicting the steps employed in the use of a single wire to carry both digital information and analog control signals.

### DETAILED DESCRIPTION OF THE INVENTION

In accordance with the present invention, a method and system for controlling the output voltage of an AC adapter and for obtaining digital information identifying characteristics of the AC adapter over a single wire coupling the AC adapter to end or electronic equipment is disclosed.

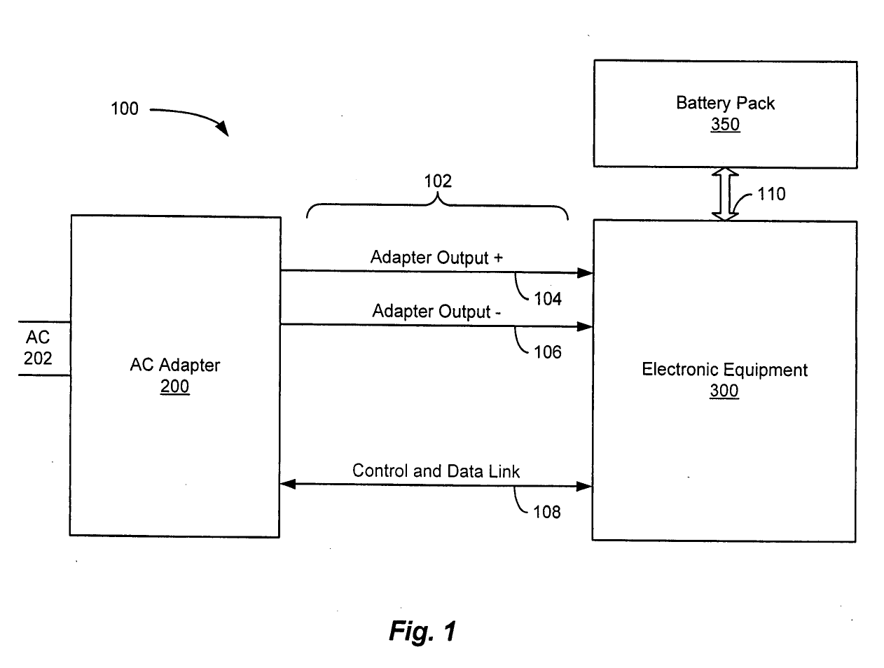

Referring to FIG. 1, the system 100 includes an AC power adapter 200, electronic equipment 300, such as a notebook computer, and a battery pack 350. The AC adapter 200 generates positive and negative voltage outputs which are couplable to the electronic equipment 300 via an interface cable 102. The wires carrying the positive and negative output voltages are identified as Adapter Output+104 and Adapter Output−106 respectively.

Additionally, the interface cable between the AC adapter 200 and the electronic equipment 300 includes a control and data link 108. The use of the control and data link 108 is described in greater detail below.

The electronic equipment 300 is also electrically coupled to the battery pack 350 via a battery interface 110 as known in the art. The battery pack 350 may include one or more rechargeable batteries and serves to power the electronic equipment 300 when the AC adapter 200 is not connected to the electronic equipment 300 or not coupled to AC power via inputs 202. When the AC adapter 200 is line powered and coupled to the electronic equipment 300 via the interface cable 102, the AC adapter 200 powers the electronic equipment 300 and charges the battery pack 350.

The AC adapter 200 and the electronic equipment 300 communicate cooperatively over the control and data link 108 in first and second operating modes. More specifically, in the first operating mode, also referred to herein as the digital mode, the AC adapter 200 is configured to permit the electronic equipment 300 to retrieve digital information from the AC adapter 200 serially over the control and data link 108. The digital information may include information identifying the AC adapter 200 or voltage or other characteristics of the AC adapter 200. In the second operating mode, also referred to herein as the analog mode, the control and data link 108 is employed to carry an analog signal which is part of a control loop. The analog signal is employed to generate an error signal which controls the DC output voltage of the AC adapter 200. The analog signal is also employed to control transitions from the analog mode to the digital mode as subsequently described in greater detail.

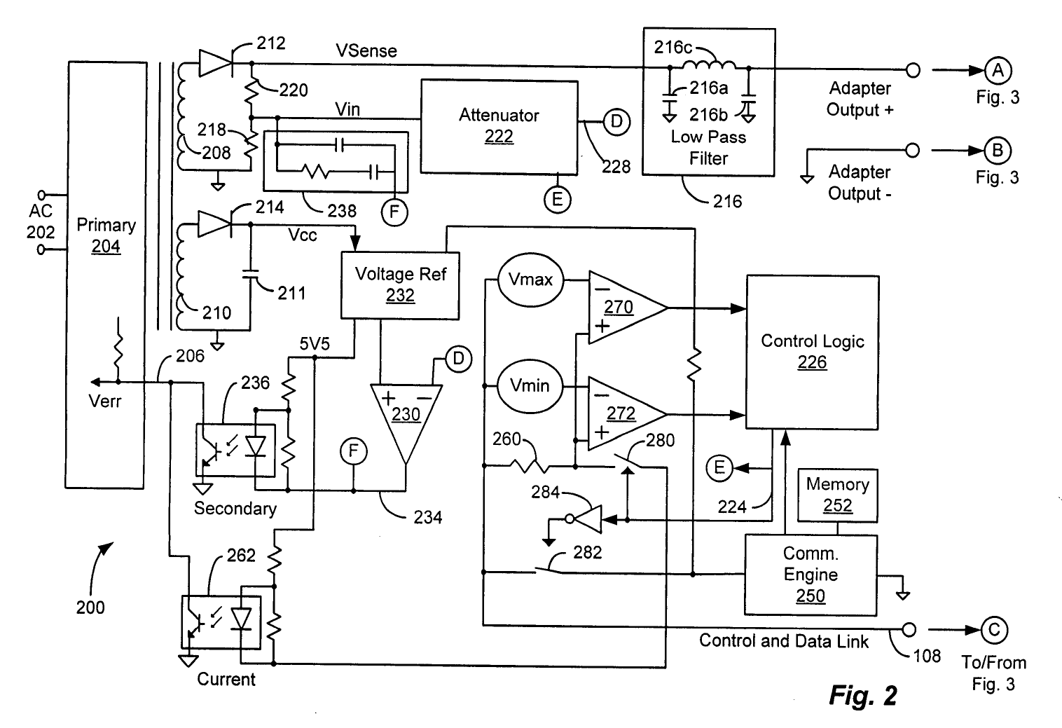

One embodiment of an AC adapter 200 operative in accordance with the present invention is depicted in FIG. 2. Referring to FIG. 2, the AC adapter 200 receives AC line power at AC inputs 202. The AC line power is applied to a primary side converter 204 that is responsive to an error signal 206 to modify the duty cycle of the primary side waveform. The secondary side of the AC adapter input circuitry includes first and second windings 208 and 210, respectively that are coupled to rectifier diodes 212, 214 to produce DC voltages VSense and Vcc. The signal VSense is coupled to the adapter voltage output Adapter Output+ through a low pass filter 216 comprising capacitors 216a, 216b and inductor 216c.

Resistors 218, 220 form a voltage divider which provides an input voltage Vin to a first control loop that serves to control the adapter output voltage. Vin is coupled to an attenuator 222. The attenuator 222 is used to modify the first control loop so that the adapter output voltage is set either to the maximum output voltage for the AC adapter (in the analog mode) or an output voltage that is less than the maximum output voltage by a predetermined percentage (in the digital mode). The selection of the specific attenuator characteristic occurs in response to a mode selection signal 224 from AC adapter control logic 226. More specifically, in one exemplary embodiment, the mode selection signal 224 is asserted when the AC adapter is in the analog mode and deasserted when the AC adapter is in the digital mode. The attentuator 222 modifies the attentuator output 228 when the mode selection signal 224 specifies the digital mode so that the first control loop produces an error signal 206 that causes the AC adapter output voltage to be set at a predetermined percentage of the maximum output voltage. When the mode selection signal 224 specifies the analog mode, the attenuator 222 produces an output signal 228 that causes the first control loop to produce an error signal 206 that causes the AC adapter 200 to produce the maximum specified output voltage.

The attenuator output signal 228 is coupled to the inverting input of an operational amplifier 230. The non-inverting input of the operational amplifier 230 is coupled to the output of a voltage reference source 232. The operational amplifier 230 produces an output signal 234 that is coupled to a first optical isolator 236. The first optical isolator 232 is coupled to the error signal 206 which completes the first control loop. The high frequency gain of the first control loop is controlled by a low pass filter 238 that is coupled between the Vin input signal to the attenuator 222 and the output signal 234 from the operational amplifier 230.

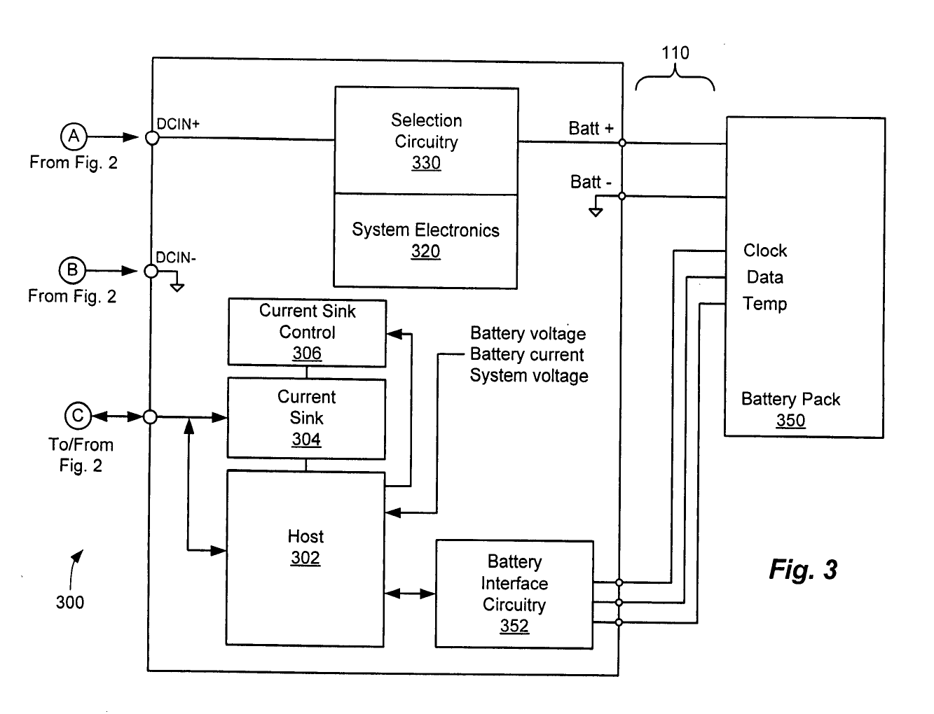

The AC adapter 200 further includes a communication engine 250 that is communicative to a memory 252. The communication engine 250 is cooperative with a host 302 in the electronic equipment 300 (see FIG. 3) to communicate digital information retrieved from the memory 252 over the control and data link 108 to the host 302 when the AC adapter is configured in the first or digital operating mode as subsequently discussed in greater detail.

The AC adapter 200 also includes circuitry that is cooperative with circuitry within the electronic equipment 300 to form a second control loop to permit the AC adapter output voltage to be controlled based upon commands sent from the end equipment 300. More specifically, when the AC adapter 200 is configured in the second or analog operating mode, the control and data link 108 is employed to carry an analog control signal within the second control loop.

The operation of the second control loop including the AC power adapter and circuitry within the electronic equipment 300 is further described in U.S. application Ser. No. 10/983,284, filed Nov. 5, 2004, entitled Methods and Systems for Controlling an AC adapter and Battery Charger in a Closed Loop Configuration, which application is assigned to the same assignee as the present application and is incorporated herein by reference.

An illustrative embodiment of the electronic equipment 300 is depicted in FIG. 3. Referring to FIG. 3 the electronic equipment 300 includes a current sink 304 that sinks current through the control and data link 108 under the control of current sink control circuitry 306.

As shown in FIG. 2, when the AC adapter is configured in the analog mode and the control and data link 108 is carrying a control current, the current passes through a resistor 260 and drives a second optical isolator 262. The second optical isolator 262 is coupled to the primary side 204 and controls the duty cycle of the primary side converter in response to variations in the control current sent from the electronic equipment 300.

The positive and negative outputs from the AC power adapter 200 are coupled to the DCIN+ and DCIN− inputs of the electronic equipment 300 via the interface cable 102 (see FIG. 1). The DC input voltage is coupled to the system electronics 320 and/or the battery pack 350 during charging via the selection circuitry 330. When the electronic equipment is being powered by the battery pack 350, the power is coupled to the system electronics via the selection circuitry 330. The battery pack includes a number of interface signals 110 that are coupled to battery interface circuitry 352 within the electronic equipment 300 and monitored by the host 302.

As shown in FIG. 2, the AC adapter 200 includes first and second comparators 270, 272 that are used to determine whether the control current through the control and data link 108 is above or below predetermined current thresholds. More specifically, the inverting input of the first comparator 270 is coupled to a positive side of a voltage reference Vmax. The negative side of the voltage reference is coupled a first end of the resistor 260. The first end of the resistor 260 is also coupled to the control and data link 108. The second end of the resistor 260 is coupled to the non-inverting input of the first comparator 270. Consequently, when the current passing through the control and data link 108 exceeds a first predetermined current threshold, the output of the first comparator 270 is asserted. The first comparator output signal is coupled to the input of the control logic 226.

The second end of the resistor 260 is also coupled to the non-inverting input of the second comparator 272. Additionally, a positive side of a second voltage reference Vmin is coupled to the inverting input of the second comparator 272. The output of the second comparator is coupled to the control logic 226. Consequently, when the current passing through the control and data link decreases below a second predetermined current threshold, the output of the second comparator 272 is asserted and conveyed to the control logic 226.

As previously noted, the mode selection signal 224 specifies whether the AC adapter is in the digital or analog mode. The AC adapter 200 includes first and second switches 280 and 282 (see FIG. 2) which are driven by opposite ends of an inverter 284. In the first or digital operating mode, the second switch 282 is closed and the first switch 280 is open. In this configuration the communication engine is coupled to the control and data link 108 and the second control loop is disconnected. In the digital mode, the communication engine can communicate with the host 302 (see FIG. 3) over the data and control link 108. In the second or analog operating mode, the first switch 280 is closed and the second switch 282 is open. In this configuration, the second control loop is operative and the communication engine output is disconnected from the control and data link 108.

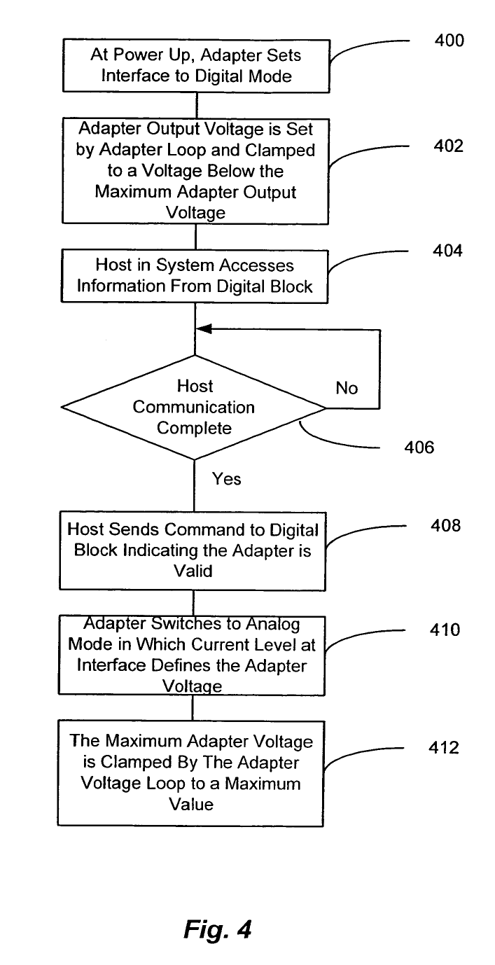

The operation of the disclosed system is further described with respect to FIG. 2-4. As illustrated in step 400, the control circuitry 226 is initialized on power up in the first operating mode, i.e. the digital mode, in which the communication engine 250 is coupled to the electronic equipment 300 via the control and data link 108. As depicted in step 402, the control logic 226 controls the attenuator 222 so that the adapter output voltage is set at the predetermined percentage of the maximum specified adapter output voltage. In this manner, the voltage applied to the electronic equipment 300 is limited to a voltage that will not cause any harm to the circuitry within the electronic equipment 300 due to an overvoltage condition.

As depicted in step 404, the host 302 next accesses the digital information stored in the memory 252 via the communication engine 250 over the control and data link 108. The information may be forwarded by the communication engine 250 in response to a command from the host 302 or at the initiation of the control logic 226. The host 302 next determines if the information has been received and if the information indicates that the AC adapter 200 is a valid adapter, as illustrated in decision step 406. In the event the host 302 determines that the attached adapter is a valid adapter, the host 302 transmits a command to the communication engine 250 that indicates that the adapter has been determined to be valid, as illustrated in step 408. In response to the receipt of the indication that the AC adapter has been determined by the host 302 to be a valid adapter, the communication engine 250 signals the control logic 226. In response to receipt of the signal at the control logic 226 indicating that the AC adapter is valid, the AC adapter 200 switches to the second operating or analog mode in which the current sink 304 sinks current over the control and data link 108 from the AC power adapter 200 as illustrated in step 410. In this mode the second control loop is operative to control the output voltage of the AC adapter based on the voltage sensed at DCIN+. As depicted in step 412, in the analog mode, the AC adapter output voltage is clamped by the adapter control loop to the maximum adapter output voltage.

The AC adapter remains in the second operating mode until either the first or second comparator output indicates that the control logic should transition to the digital mode. As previously discussed, if the current level through the control and data link 108 exceeds a first predetermined current level, as sensed by the first comparator 270, the AC adapter 200 reverts to the digital mode. Additionally, if the current level in the control and data link 108 goes below a second predetermined current level which is less than the first predetermined current level, as sensed by the second comparator 272, the AC adapter 200 reverts to the digital mode. The detection of a current level in the control and data link 108 below the second predetermined level indicates that the electronic equipment 300 has been disconnected from the AC adapter 200.

In the foregoing manner, the control and data link 108 between the AC adapter 200 and the electronic equipment 300 may be employed to convey both digital information used by the electronic equipment to validate the AC adapter and to convey an analog signal forming a part of the second control loop.

It will be appreciated by those of ordinary skill in the art that the host may be implemented as a microprocessor, a controller, hardware logic, or any suitable combination of hardware and software operative to perform the functions herein described.

Furthermore, while the control signal passed through the control and data link 108 is described as a current in the illustrated embodiment, it will be appreciated that the control signal may be implemented as a varying analog voltage.

Finally, it will be appreciated that modifications to and variations of the above-described apparatus and method may be made without departing from the inventive concepts disclosed herein. Accordingly, the invention should not be viewed as limited except by the scope and spirit of the appended claims.

What is claimed is:

1. An AC power adapter for providing a DC output voltage for powering an electronic device, said AC power adapter comprising:
a communication engine for serially communicating digital information over a single wire interface for receipt by a host in an electronic device and receiving digital information over said single wire interface from said host;
interface circuitry for conveying an analog control signal over said single wire interface to control said DC output voltage; and
control circuitry operative to select between a first operating mode in which said communication engine utilizes said single wire interface and a second operating mode in which said interface circuitry utilizes said single wire interface.

2. The adapter of claim 1 wherein said control circuitry is operative to select said first operating mode upon power up of the adapter.

3. The adapter of claim 1 wherein said communication engine is operative in response to receipt of a first predetermined communication from said host to transmit digital information over said single wire interface for receipt by said host.

4. The adapter of claim 3 further including at least one memory for storing said digital information, wherein said communication engine is operative to retrieve said digital information from said memory.

5. The adapter of claim 3 wherein said digital information transmitted over said single wire interface comprises information pertaining to said AC power adapter.

6. The adapter of claim 5 wherein said information pertaining to said AC power adapter comprises data identifying said AC power adapter.

7. The adapter of claim 5 wherein said information pertaining to said AC power adapter comprises data identifying a maximum output voltage of said AC power adapter.

8. The adapter of claim 3 wherein said communication engine is operative in response to receipt of a second predetermined communication from said host to generate a first control signal and said control circuitry is operative in response to said first control signal to select said second operating mode.

9. The adapter of claim 1 wherein said control circuitry is further operative to set the output voltage of said AC power adapter at a first predetermined output voltage in said second operating mode and is operative to set the output voltage of said AC power adapter to a second predetermined output voltage in said first operating mode, wherein said second predetermined output voltage is less than said first predetermined output voltage.

10. In a system including an AC power adapter producing a DC output voltage for powering an electronic device, a method for controlling said AC power adapter comprising:
selecting within said AC power adapter between a first operating mode and a second operating mode;
in said first operating mode, transmitting digital information to said electronic device and receiving digital information from said electronic device over a single interface wire coupling said AC power adapter and said electronic device; and
in said second operating mode transmitting an analog control signal over said single interface wire and controlling said DC output voltage of said AC power adapter based at least in part on said analog control signal.

11. The method of claim 10 wherein said analog control signal comprises a current.

12. The method of claim 11 further including the step of generating said current using current sink control logic controlling a current sink within said electronic device.

13. The method of claim 10 further including selecting said first operating mode in response to power up of said adapter.

14. The method of claim 10 further including:
transmitting digital information over said single wire interface from a communication engine in said adapter for receipt by said electronic device;
receiving at said communication engine a first predetermined communication from said electronic device over said single wire interface; and
in response to the receipt of said first predetermined communication, changing from said first operating mode to said second operating mode.

15. The method of claim 14 further including the step of transitioning said AC power adapter from said second operating mode to said first operating mode in the event said analog control signal has an amplitude that exceeds a first analog threshold.

16. The method of claim 14 further including the step of transitioning said AC power adapter from said second operating mode to said first operating mode in the event said analog control signal has an amplitude less than a second analog threshold.

17. The method of claim 14 further including prior to said transmitting step, the step of retrieving said digital information from said memory.

18. The method of claim 14 wherein said transmitting step comprises the step of transmitting digital information pertaining to at least one characteristic of said AC power adapter.

19. The method of claim 14 wherein said transmitting step comprises the step of transmitting digital information that specifies a maximum output voltage of said AC power adapter.

20. The method of claim 14 wherein said transmitting step comprises the step of transmitting digital information that identifies said AC power adapter.

21. The method of claim 10 further including the steps of:
controlling said DC output voltage of said AC power adapter to assume a first predetermined voltage when said first operational mode is selected; and
controlling said DC output voltage of said AC power adapter to assume a second predetermined voltage when said second operating mode is selected, wherein said first predetermined voltage is less than said second predetermined voltage.
